(19) United States
(12) Patent Application Publication
(10) Pub. No.: US 2024/0184844 A1
(43) Pub. Date: Jun. 6, 2024

(54) METHOD AND SYSTEM FOR PREDICTING HEAT EXCHANGER PERFORMANCE, ELECTRONIC DEVICE AND STORAGE MEDIUM

(71) Applicant: China University of Petroleum (East China), Qingdao (CN)

(72) Inventors: Xinyue Duan, Qingdao (CN); Manrui Xu, Qingdao (CN); Liang Gong, Qingdao (CN); Chuanyong Zhu, Qingdao (CN); Jiadong Li, Qingdao (CN); Tianpeng Zhang, Qingdao (CN)

(73) Assignee: China University of Petroleum (East China), Qingdao (CN)

(21) Appl. No.: 18/490,501

(22) Filed: Oct. 19, 2023

(30) Foreign Application Priority Data
Oct. 19, 2022 (CN) 202211280285.X

(51) Int. Cl. G06F 17/11; G01N 25/18

(52) U.S. Cl. CPC G06F 17/11; G01N 25/18; F28F 2200/00

(57) ABSTRACT

A method and system for predicting heat exchanger performance, an electronic device and a storage medium are provided. The method comprises: acquiring a flow unit of the heat exchanger and constructing a physical model of the flow unit according to structural parameters of the heat exchanger; constructing a coupled model of an interphase transfer mechanism for oil-gas-water three-phase flow using computational fluid dynamics according to the physical model; constructing a fully coupled population balance model for flow and heat transfer of oil-gas-water three-phase flow; solving the fully coupled population balance model to obtain a model calculation result and determining a Nusselt number and a Fanning friction factor; and determining a comprehensive heat transfer factor, wherein the comprehensive heat transfer factor is used to evaluate heat transfer performance of the heat exchanger.

### CROSS REFERENCE TO RELATED APPLICATION

This patent application claims the benefit and priority of Chinese Patent Application No. 202211280285.X, filed on Oct. 19, 2022, the disclosure of which is incorporated by reference herein in its entirety as part of the present.

### TECHNICAL FIELD

The present disclosure relates to the field of heat transfer performance of a heat exchanger, and in particular to a method and system for predicting heat exchanger performance, an electronic device and a storage medium.

### BACKGROUND

Waste heat recovery and utilization is an important way to improve energy utilization economy and conversion efficiency so as to realize energy saving and emission reduction. For the oil industry as an energy-intensive industry, the water content of produced fluid in oil field is increasing year by year, a large amount of industrial wastewater with temperature range from 30° C. to 70° C. is produced, which is great potential for waste heat recovery and utilization.

A heat exchanger is a key device for waste heat power recovery and heat utilization. Most of the current wastewater heat exchanger are designed based on heat transfer process of hot water and cold water, which are used for industrial wastewater from oil fields that contains a small amount of crude oil and gas, resulting in a significant reduction in it's entire performance. In order to make the heat exchanger better serve the waste heat utilization project of produced water, studying a mechanism method of the flow and heat transfer performance on oil-gas-water three-phase flow heat exchanger, predicting the flow pattern evolution and the heat transfer regularity of the oil-gas-water three-phase flow, revealing the mechanism of bubble/oil droplet movement, size distribution, and their influence on the heat exchange efficiency, and obtaining the optimized structure of the heat exchanger are of great significance for improving the utilization rate of industrial waste heat resources.

Numerical method is an effective technical means to study the flow and heat transfer in the heat exchanger. In this field, the research on performance prediction and structural optimization of the heat exchanger are limited to a working medium with flow regime of single-phase flow or some gas-water two-phase flow. In recent years, as multi-phase flow mechanism model, a fully coupled population balance method has made some progress in it's equation discretization, it's application coupled with a multi-fluid framework, and the development of a coalescence and break up function, and has been initially applied to gas-water two-phase flow and oil-water two-phase flow, providing an effective prediction method. However, this coupled method still lack in research on reasonable interphase transfer mechanisms in the flow and heat transfer of oil-gas-water three-phase flow, and it has not been successfully applied in the flow and heat transfer problems under fluid-solid coupled conditions in three-phase waster fluid heat exchangers.

### SUMMARY

The purpose of the present disclosure is to provide a method and system for predicting heat exchanger performance, an electronic device and a storage medium, so as to improve the prediction accuracy of the heat exchanger performance.

In order to achieve the above purpose, the present disclosure provides the following solutions.

A method for predicting heat exchanger performance is provided, comprising:

acquiring a flow unit of a heat exchanger and constructing a physical model of the flow unit according to structural parameters of the heat exchanger;

constructing a coupled model of an interphase transfer mechanism for oil-gas-water three-phase flow using computational fluid dynamics according to the physical model; wherein the coupled model of the interphase transfer mechanism for oil-gas-water three-phase flow comprises an interphase mass transfer model, an interphase momentum transfer model and an interphase energy transfer model;

constructing a fully coupled population balance model for flow and heat transfer of oil-gas-water three-phase flow according to the coupled model of the interphase transfer mechanism for oil-gas-water three-phase flow; wherein the fully coupled population balance model comprises an Euler multi-fluid model, a water-phase standard k-epsilon turbulence model, and a bubble/oil droplet zero-equation model;

solving the fully coupled population balance model to obtain a model calculation result and determining a Nusselt number and a Fanning friction factor according to the model calculation result; and

determining a comprehensive heat transfer factor according to the Nusselt number and the Fanning friction factor, wherein the comprehensive heat transfer factor is used to evaluate heat transfer performance of the heat exchanger.

In an embodiment, an expression of the interphase momentum transfer model is:

Fₗ=F_{lg}=−F_{gl}

where Fₗ is a total interphase force of water phase, F_{gl} is a interphase force acting on a gas phase in a water phase, and F_{lg} is a interphase force acting on a water phase in a gas phase.

In an embodiment, an expression of the interphase energy transfer model is:

$${\dot{Q}}_{o , 1} = \frac{{h}_{S , o} {a}_{o} ( {T}_{o} - {T}_{w} )}{{α}_{o}} \\ {\dot{Q}}_{g , 1} = \frac{{h}_{S , g} {a}_{g} ( {T}_{g} - {T}_{w} )}{{α}_{g}}$$

where \dot{Q}_{o,l} is heat transferred from a water-phase interface to an oil-phase interface, \dot{Q}_{g,l} is heat transferred from a water-phase interface to an gas-phase interface, h_{S,o} is an oil-phase interface transfer coefficient, aₒ is an interface area per unit volume of an oil phase, Tₒ is an oil-phase temperature, T_{W} is a water-phase temperature, h_{S,g} is a gas-phase interface transfer coefficient, a_{g} is an interface area per unit volume of a gas phase, T_{g} is a gas-phase temperature, α_{g} is a gas-phase volume fraction, αₒ is an oil-phase volume fraction.

In an embodiment, an expression of the Fanning friction factor is:

$$F = \frac{Δ p \times {D}_{h}}{2 \times L \times ρ \times {v}^{2}}$$

where F is the Fanning friction factor, Δp is a pressure difference between an inlet and an outlet, Dₕ is a hydraulic diameter, L is a channel length, ν is a flow velocity, and ρ is a density.

In an embodiment, an expression of the comprehensive heat exchange factor is:

PEF=(Nu/Nu₀)/(F/F₀)^{1/3}

where PEF is the comprehensive heat exchange factor, Nu is a global Nusselt number, Nu₀ is a global Nusselt number under a standard condition, F is the Fanning friction factor, and F₀ is a Fanning friction factor under the standard condition.

In an embodiment, after determining a comprehensive heat transfer factor according to the Nusselt number and the Fanning friction factor, the method further comprises:

determining optimization parameters of the heat exchanger according to a plurality of comprehensive heat exchange factors; wherein the optimization parameters comprise a corrugation height, a corrugation interval and a corrugation inclination angle.

The present disclosure further provides a system for predicting heat exchanger performance, comprising:

an acquiring module, configured to acquire a flow unit of a heat exchanger and construct a physical model of the flow unit according to structural parameters of the heat exchanger;

a module of constructing a coupled model of an interphase transfer mechanism for oil-gas-water three-phase flow, configured to construct the coupled model of the interphase transfer mechanism for oil-gas-water three-phase flow using computational fluid dynamics according to the physical model; wherein the coupled model of the interphase transfer mechanism for oil-gas-water three-phase flow comprises an interphase mass transfer model, an interphase momentum transfer model and an interphase energy transfer model;

a module of constructing a fully coupled population balance model, configured to construct the fully coupled population balance model for flow and heat transfer of oil-gas-water three-phase flow according to the coupled model of the interphase transfer mechanism for oil-gas-water three-phase flow; wherein the fully coupled population balance model comprises an Euler multi-fluid model, a water-phase standard k-epsilon turbulence model, and a bubble/oil droplet zero-equation model;

a solving module, configured to solve the fully coupled population balance model to obtain a model calculation result and determine a Nusselt number and a Fanning friction factor according to the model calculation result; and

a comprehensive heat transfer factor determining module, configured to determine a comprehensive heat exchange factor according to the Nusselt number and the Fanning friction factor, wherein the comprehensive heat transfer factor is used to evaluate heat transfer performance of the heat exchanger.

In an embodiment, an expression of the interphase momentum transfer model is:

Fₗ=F_{lg}=−F_{gl}

where Fₗ is a total interphase force of water phase, F_{gl} is a interphase force acting on a gas phase in a water phase, and F_{lg} is a interphase force acting on a water phase in a gas phase.

The present disclosure further provides an electronic device, comprising:

one or more processors; and

a storage device on which one or more programs are stored;

wherein the one or more programs, when executed by the one or more processors, cause the one or more processors to implement the method according to any one of the above.

The present disclosure further provides a computer storage medium having a computer program stored thereon, wherein the computer program, when executed by a processor, implements the method according to any one of the above.

According to the specific embodiments provided by the present disclosure, the present disclosure discloses the following technical effects.

The present disclosure comprises acquiring a flow unit of the heat exchanger and constructing a physical model of the flow unit according to structural parameters of the heat exchanger; constructing a coupled model of an interphase transfer mechanism for oil-gas-water three-phase flow using computational fluid dynamics according to the physical model; wherein the coupled model of the interphase transfer mechanism for oil-gas-water three-phase flow comprises an interphase mass transfer model, an interphase momentum transfer model and an interphase energy transfer model; constructing a fully coupled population balance model for flow and heat transfer of oil-gas-water three-phase flow according to the coupled model of interphase transfer mechanism for the oil-gas-water three-phase flow; wherein the fully coupled population balance model comprises an Euler multi-fluid model, a water-phase standard k-epsilon turbulence model, and a bubble/oil droplet zero-equation model; solving the fully coupled population balance model to obtain a model calculation result and determining a Nusselt number and a Fanning friction factor according to the model calculation result; and determining a comprehensive heat transfer factor according to the Nusselt number and the Fanning friction factor, wherein the comprehensive heat transfer factor is used to evaluate heat transfer performance of the heat exchanger. In the present disclosure, by constructing a perfect fully coupled population balance model, the influence of bubble/oil droplet movement and size distribution on the flow and heat transfer is revealed, thereby improving the prediction accuracy of the heat transfer performance.

### BRIEF DESCRIPTION OF THE DRAWINGS

In order to explain the embodiments of the present disclosure or the technical solutions of the conventional art more clearly, the accompanying drawings used in the embodiments will be briefly described below. Obviously, the accompanying drawings described below show merely some embodiments of the present disclosure. For those skilled in the art, other drawings can be obtained according to these accompanying drawings without creative efforts.

FIG. 1 is a flow chart of a method for predicting heat exchanger performance according to the present disclosure;

FIG. 2 is a schematic diagram of a flow unit extracted from a corrugated plate heat exchanger according to the present disclosure;

FIG. 3 is a schematic diagram of a physical model according to the present disclosure;

FIG. 4 is a schematic diagram of a research object when calculating a local Nusselt number according to the present disclosure;

FIGS. 5A-5B are schematic diagrams of a local Nusselt number and a local gas-phase volume distribution regularities according to the present disclosure;

FIGS. 6A-6B are distribution diagrams of an oil phase, a gas phase and a water phase in a vertical corrugated channel according to the present disclosure;

FIG. 7 is a graph showing the variation of a comprehensive heat transfer performance factor with an inlet flow velocity at different corrugation heights according to the present disclosure; and

FIG. 8 is a flow chart of a method for predicting heat exchanger performance according to the present disclosure.

### DETAILED DESCRIPTION OF THE EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiment of the present disclosure, all other embodiments obtained by those skilled in the art without creative efforts shall fall within the scope of the present disclosure.

The purpose of the present disclosure is to provide a method and system for predicting heat exchanger performance, an electronic device and a storage medium, so as to improve the prediction accuracy of the heat exchanger performance.

In order to make the above objectives, features and advantages of the present disclosure clearer and more comprehensible, the present disclosure is explained in further detail below in conjunction with the accompanying drawings and specific implementations.

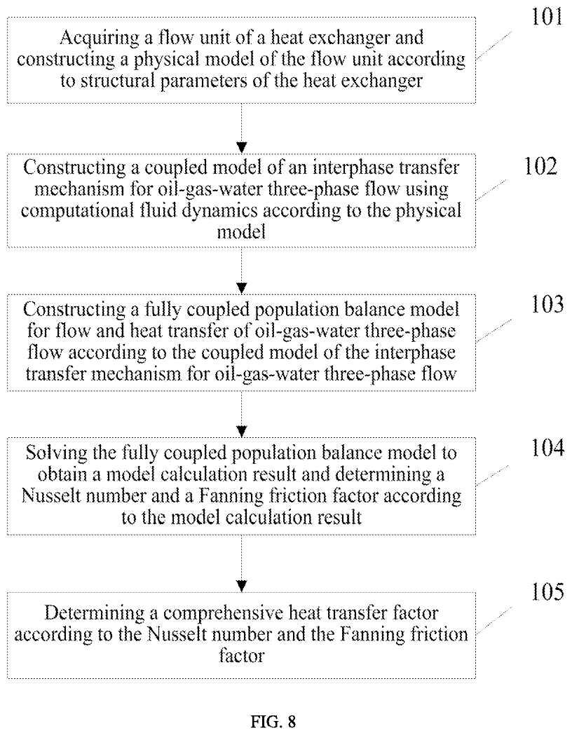

As shown in FIG. 1 and FIG. 8, the method for predicting heat exchanger performance according to the present disclosure comprises steps 101-105.

In step 101, a flow unit of the heat exchanger is acquired and a physical model of the flow unit is constructed according to structural parameters of the heat exchanger.

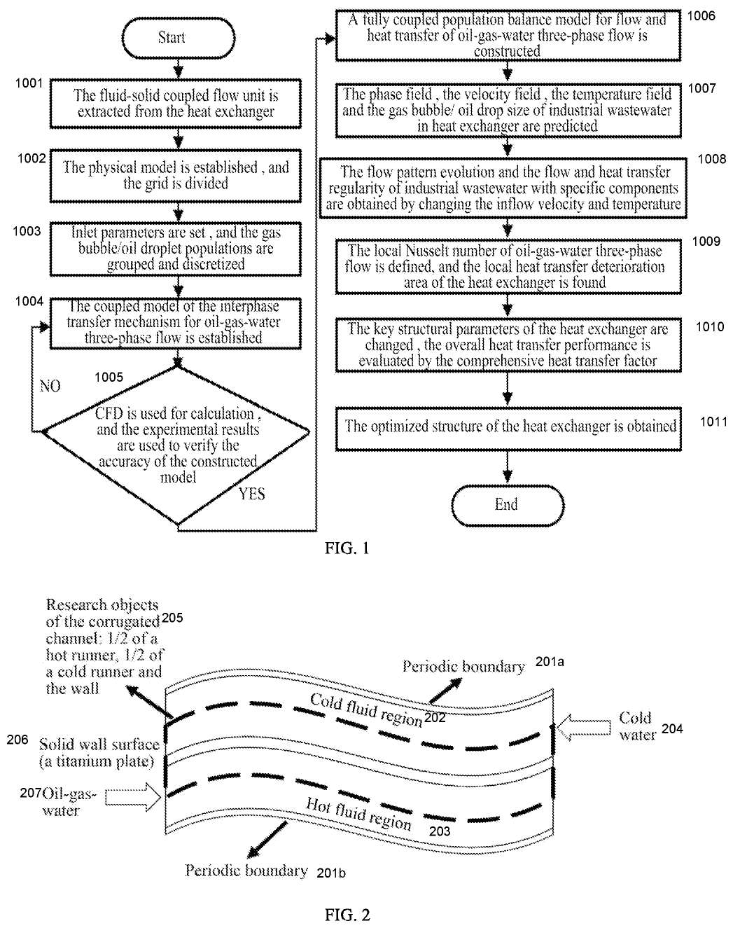

The fluid-structure coupled heat transfer unit is extracted from a corrugated plate heat exchanger (1001), covering a half of a cold runner, a half of a hot runner (205) and a titanium plate 206, as shown in FIG. 2. The whole corrugated plate heat exchanger is formed by stacking many plates, and the stacked channels are alternately distributed with cold and hot runners (cold fluid region 202 with cold water 204 and hot fluid region 203 with oil-gas-water 207). Considering that there are many control equations in the numerical calculation method, the system is simplified into a flow unit as a physical model with the upper, lower, left and right periodic boundary conditions 201a-b, to simulating the whole heat exchanger alternatively, which greatly reduces the calculation amount.

The structural parameters of the heat exchanger are selected, the physical model of the flow unit is constructed, and the grid is divided (1002). The physical model is shown in FIG. 3 and the specific structural parameters are shown in Table 1. The dashed frame on the left side of FIG. 3 illustrates two thin corrugated plate channels formed by stacking three plates 303, one of two thin corrugated plate channels is a cold runner 301 and the other is a hot runner 302. The elongated corrugated channel on the right side of FIG. 3 is a flow unit cut from the dashed frame on the left side, which comprises a cold runner, a hot runner and three corrugated plates. FIG. 2 is a cross-sectional view of the constructed physical model, and the flow unit consists of a corrugated plate in the middle and a half of the cold runner and a half of the hot runner which both are adjacent to the corrugated plate in the middle.

TABLE 1
Structural Parameter Setting Table

| Parameter name | Size/mm | Parameter | Size/mm |
|---|---|---|---|
| Channel height | 3 | Corrugation height | 3 |
| Channel width | 6 | Corrugation length | 16 |
| Thickness of a | 0.5 | Length of the inlet | 50 |
| titanium plate | | and the outlet | |

In step 102, a coupled model of an interphase transfer mechanism for oil-gas-water three-phase flow is constructed using computational fluid dynamics according to the physical model; wherein the coupled model of the interphase transfer mechanism for oil-gas-water three-phase flow comprises an interphase mass transfer model, an interphase momentum transfer model and an interphase energy transfer model.

The flow velocity, the phase volume fraction and the bubble/oil droplet size range of oilfield produced water are set, and the bubble population and oil droplet population are grouped and discretized (1003) according to the gas bubble/oil droplet size range.

The coupled model of the interphase transfer mechanism for oil-gas-water three-phase flow is constructed (1004), including the interphase mass transfer model, the interphase momentum transfer model and the interphase energy transfer model, which modify transfer equations for the mass, momentum and energy and turbulence equations of oil-gas-water three-phase flow, respectively. Computational Fluid Dynamics (CFD) is used for calculation, and a result of the calculation is compared with the experimental result to optimize the coupled model of the interphase transfer mechanism (1005). The model mainly comprises the following parts.

### (a) Interphase Mass Transfer Model

The gas-phase additional mass source S_{di} resulted from the gas bubble/oil droplet coalescence and break up, that is, the interphase mass transfer model, may be expressed as:

S_{di}=(Pᵢ^{C}+Pᵢ^{B}−Dᵢ^{C}−Dᵢ^{B}) (1)

where pᵢ^{C} indicates a gas bubble/oil droplet generation rate formed by coalescence, Dᵢ^{C} indicates a gas bubble/oil droplet mortality rate formed by coalescence, Pᵢ^{B} indicates a gas bubble/oil droplet generation rate caused by break up, and Dᵢ^{B} indicates a gas bubble/oil droplet mortality rate caused by break up, which may be respectively expressed as:

$$\begin{matrix}{P}_{i}^{C} = {( {ρ}_{j}^{g} {α}_{j}^{g} )}^{2} \frac{1}{2} {\sum }_{p} {\sum }_{l} {f}_{p} {f}_{l} \frac{{M}_{p} + {M}_{l}}{{M}_{p} {M}_{l}} a ( {M}_{p} , {M}_{l} ) & ( 2 ) \\ {D}_{i}^{C} = {( {ρ}_{j}^{g} {α}_{j}^{g} )}^{2} {\sum }_{p} {f}_{i} {f}_{p} \frac{1}{{M}_{p}} a ( {M}_{i} , {M}_{p} ) & ( 3 ) \\ {P}_{i}^{B} = {( {ρ}_{j}^{g} {α}_{j}^{g} )}^{2} {\sum }_{p} r ( {M}_{p} , {M}_{i} ) {f}_{p} & ( 4 ) \\ {D}_{i}^{B} = {ρ}_{j}^{g} {α}_{j}^{g} {f}_{i} {\sum }_{p} r ( {M}_{i} , {M}_{p} ) & ( 5 )\end{matrix}$$

where α indicates a volume fraction, ƒᵢ indicates a percentage of an i-th group of gas bubbles, ρ indicates a density, M indicates mass of a bubble cluster, a superscript g indicates a gas phase, i, j, l and p indicate the number of different dispersed phase groups, ƒₚ indicates a percentage of a p-th group of gas bubbles, ƒₗ indicates a percentage of an l-th group of gas bubbles, a indicates a coalescence rate of gas bubbles/oil droplets, and r indicates a break up rate of gas bubbles/oil droplets.

### (b) Interphase Momentum Transfer Model

Fₗ=F_{lg}=−F_{gl} (6)

μ_{GI,I}=ρₗC_{μ,GI}α_{g}d_{g,i}|u_{g}−uₗ| (7)

μ_{OI,I}=ρₗC_{μ,OI}αₒd_{o,i}|uₒ−uₗ| (8)

where Fₗ is a total interphase force of water phase, F_{gl} is a interphase force acting on a gas phase in a water phase, and F_{lg} is a interphase force acting on a water phase in a gas phase water phase in a gas phase. F₁=F_{lg} indicates momentum transfer of a water phase to a gas phase, Fₗ=F_{lg} indicates momentum transfer of a gas phase to a liquid phase, ρₗ indicates a liquid-phase density, u_{g} indicates a gas-phase velocity vector, uₗ indicates a water-phase velocity vector, uₒ indicates an oil-phase velocity vector, o indicates an oil phase, d_{g,i} indicates a diameter of an i-th group of gas bubbles, d_{o,i} indicates a diameter of an i-th group of oil droplets, C_{μ,GI} is an additional viscosity coefficient induced by the gas phase, and C_{μ,OI} is an additional viscosity coefficient induced by the gas phase/the oil phase, both of which are 0.6. μ_{GI,I} is an additional viscosity induced by the gas phase, and μ_{OI,I} is an additional viscosity induced by the oil phase. Formulas (7) and (8) are used to modify the water-phase turbulence equations of Formulas (21) and (22).

### (c) Interphase Energy Transfer Model

$${\dot{Q}}_{o , 1} = \frac{{h}_{S , o} {a}_{o} ( {T}_{o} - {T}_{w} )}{{α}_{o}} \qquad ( 9 )$$

$${\dot{Q}}_{g , 1} = \frac{{h}_{S , g} {a}_{g} ( {T}_{g} - {T}_{w} )}{{α}_{g}} \qquad ( 10 )$$

where \dot{Q}_{o,l} is heat transferred from a water-phase interface to an oil-phase interface, \dot{Q}_{g,l} is heat transferred from a water-phase interface to an gas-phase interface, h_{S,o} is an oil-phase interface transfer coefficient, aₒ is an interface area per unit volume of an oil phase, Tₒ is an oil-phase temperature, T_{W} is a water-phase temperature, h_{S,g} is a gas-phase interface transfer coefficient, a_{g} is an interface area per unit volume of a gas phase, T_{g} is a gas-phase temperature, α_{g} is a gas-phase volume fraction, αₒ is an oil-phase volume fraction.

In step 103, a fully coupled population balance model for the flow and heat transfer of oil-gas-water three-phase flow is constructed according to the coupled model of the interphase transfer mechanism for oil-gas-water three-phase flow (1006); wherein the fully coupled population balance model comprises an Euler multi-fluid model, a water-phase standard k-epsilon turbulence model, and a bubble/oil droplet zero-equation model. Formula (6) is used in Formulas (12), (15) and (18), Formulas (7) and (8) are used to modify the water-phase turbulence equations of Formulas (21) and (22), and Formulas (9) and (10) are used in Formulas (13), (16) and (19).

Based on the Euler multi-fluid model, the water-phase k-epsilon turbulence model, and the gas/oil-phase zero-equation model framework, by coupling a plurality of groups of bubble population balance models and a plurality of groups of oil droplet population balance models, namely Formulas (1)-(5), (14) and (17), the fully coupled population balance model for the flow and heat transfer of oil-gas-water three-phase flow is constructed. Specifically, the plurality of groups of bubble population balance models and the plurality of groups of oil droplet population balance models are coupled with the multi-fluid model, the water-phase k-epsilon turbulence model, and the gas/oil-phase zero-equation model to obtain the fully coupled population balance model for the flow and heat transfer of oil-gas-water three-phase flow. The fully coupled population balance model for the flow and heat transfer of oil-gas-water three-phase flow mainly comprises the following control equations:

### (a) Euler Multi-Fluid Model

Water-phase continuity equation:

∇·(αₗρₗuₗ)=0 (11)

Water-phase momentum equation:

∇·(αₗρₗuₗuₗ)=−αₗ∇P+αₗρₗγ+∇·[αₗμ_{e,l}(∇uₗ+(∇uₗ)^{T})]+Fₗ (12)

Water-phase energy equation:

∇·(αₗρₗuₗc_{p,l}T_{W})=∇·(αₗλₗ∇T_{W})−(\dot{Q}_{o,l}+\dot{Q}_{g,l}) (13)

Oil-phase continuity equation:

∇·(αₒρₒuₒƒᵢ)=S_{di} (14)

Oil-phase momentum equation:

∇·(αₒρₒuₒuₒ)=−αₒ∇P+αₒρₒγ+∇·[αₒμ_{e,o}(∇uₒ+(∇uₒ)^{T})]+Fₒₗ (15)

Oil-phase energy equation:

∇·(αₒρouₒc_{p,o}Tₒ)=∇·(αₒλₒ∇Tₒ)+\dot{Q}_{o,l} (16)

Gas-phase continuity equation:

∇·(α_{g}ρ_{g}u_{g}ƒᵢ)=S_{di} (17)

Gas-phase momentum equation:

∇·(α_{g}ρ_{g}u_{g}u_{g})=−α_{g}∇P+α_{g}ρ_{g}γ+∇·[α_{g}μ_{e,g}(∇u_{g}+(∇u_{g})^{T})]+F_{gl} (18)

Gas-phrase energy equation:

∇·(α_{g}ρᵤu_{g}c_{p,g}T_{g})=∇·(α_{g}λ_{g}∇T_{g})+\dot{Q}_{gl} (19)

where α₁ indicates a water-phase volume fraction, ρₒ indicates an oil-phase density, ρ_{g} indicates a gas-phase density, γ indicates an acceleration of gravity, τ indicates a shear stress, P indicates a pressure, Fₗ, Fₒₗ and F_{gl} represent interphase forces acting on the water phase, the oil phase and the gas phase, respectively, and Ranz and Marshall model is selected. ∇ indicates a Hamilton operator, μ_{e,o} indicates an oil-phase viscosity, μ_{e,g} indicates a gas-phase viscosity, c_{p,1} indicates a water-phase specific heat at constant pressure, c_{p,o} indicates an oil-phase specific heat at constant pressure, and c_{p,g} indicates a gas-phase specific heat at constant pressure. λₗ indicates a water-phase thermal conductivity, λₒ indicates an oil-phase thermal conductivity, λ_{g} indicates a gas-phase thermal conductivity, μ_{e,l} indicates an effective viscosity, T_{W} indicates a water-phase temperature, and Tₒ indicates an oil-phase temperature, T_{g} indicates a gas-phase temperature.

The effective viscosity μ_{e,l} in the continuous phase equation consists of the turbulent viscosity μ_{T,1} and the dispersed phase induced viscosity μ_{BI,l}.

μ_{e,l}=μ_{T,l}+μ_{BI,l} (20)

### (b) Water-Phase Standard K-Epsilon Turbulence Model

$$\frac{\partial {ρ}_{1} {α}_{1} {k}_{1}}{\partial t} + ∇ \cdot ( {ρ}_{1} {α}_{1} {u}_{1} {k}_{1} ) = - ∇ \cdot ( {α}_{1} \frac{{μ}_{T , 1}}{{σ}_{k}} ∇ \cdot {k}_{1} ) + {α}_{1} ( {G}_{k} - ρ {ε}_{1} ) + {G}_{b} - {Y}_{M} \qquad ( 21 )$$

$$\frac{\partial {ρ}_{1} {α}_{1} {ε}_{1}}{\partial t} + ∇ \cdot ( {ρ}_{1} {α}_{1} {u}_{1} {ε}_{1} ) = - ∇ \cdot ( α \frac{{μ}_{T , 1}}{{σ}_{ε}} ∇ \cdot {ε}_{1} ) + {C}_{s 1} \frac{{ε}_{1}}{{k}_{1}} ( {G}_{k} - {C}_{s 2} {ρ}_{1} {ε}_{1} ) + {C}_{s 3} \frac{{G}_{b}}{{τ}_{b i t}} \qquad ( 22 )$$

where Gₖ indicates turbulence kinetic energy caused by an average velocity gradient, which may be expressed by Gₖ=τₗ:uₗ; G_{b} indicates bubble-induced turbulence kinetic energy; Y_{M} is a contribution of a fluctuating dilatation rate to a total dissipation rate in a compressible turbulence; C_{ε1}, C_{ε2} and C_{ε3} indicate turbulence model constants, σ_{ε} and σₖ indicate turbulent Prandtl numbers of k and ε, respectively, which are: C_{249 1}=1.44, C_{ε2}=1.92, C_{μ}=0.09, σₖ=1, σ_{ε}=1.3. ε indicates a turbulent dissipation rate, τ_{bit} indicates turbulent vortex dissipation characteristic time, and k indicates a turbulence kinetic energy. μ_{T,l} indicates a continuous phase turbulent viscosity.

### (c) Bubble/Oil Droplet Zero-Equation Model

$${μ}_{t} = ρ {m}_{μ} {U}_{t} {l}_{t} \qquad ( 23 )$$

$${l}_{t} = ( {V}_{D}^{\frac{1}{3}} ) / 7 \qquad ( 24 )$$

where Uₜ is a turbulence velocity scale, in which a maximum velocity in a fluid domain is taken; lₜ is a turbulence length scale, m_{μ} is a proportional constant, and V_{D} is a volume of a fluid domain. μₜ is a dispersed phase turbulent viscosity.

Formulas (1)-(5) are the population balance model, which are used to describe the size change of gas bubbles and oil droplets; Formulas (11)-(20) are the Euler multi-fluid model, which are used to describe the flow and heat transfer of oil-gas-water three-phase flow in the corrugated plate heat exchanger; Formulas (21)-(24) are the turbulence model, which are used to describe the turbulence of oil-gas-water three-phase flow in the corrugated plate heat exchanger. The three transfer mechanism models are used to modify the transfer equations for mass, momentum and energy of three phases and turbulence equations, that is, Formulas (11)-(24). The formulas of (a), (b) and (c) are all control equations used in numerical calculation.

In step 104, the fully coupled population balance model is solved to obtain a model calculation result, and a Nusselt number and a Fanning friction factor are determined according to the model calculation result. The calculation result comprises the local and global phase volume fraction, gas bubble/oil droplet size distribution, temperature and pressure of wastewater containing gas bubbles and oil droplets in the heat exchanger.

Using the discretized gas bubbles/oil droplets size distribution of oilfield produced water, the fully coupled population balance model of oil-gas-water three phase flow is grouped and solved, and the local and global phase volume fraction, bubble/oil droplet size distribution, temperature, pressure, etc. of wastewater containing gas bubbles and oil droplets in the working heat exchanger are predicted (1007), and then the local and global Nusselt number, Fanning friction factor and comprehensive heat transfer factor are calculated. The specific physical parameters are shown in Table 2.

TABLE 2
Physical Parameter Setting Table

| Parameter name | oil | gas | water |
|---|---|---|---|
| Density ρ/kg · m⁻³ | 790 | 1.185 | 997 |
| Interface tension | 0.024 | 0.0728 | 0.0218 |
| σ/N · m⁻¹ | (oil and gas) | (gas and water) | (oil and water) |
| Dynamic viscosity | 0.00164 | 0.00001831 | 0.00089 |
| μ/Pa · s | | | |
| Thermal conductivity | 0.135 | 0.0261 | 0.6069 |
| λ/W · (m · K)⁻¹ | | | |

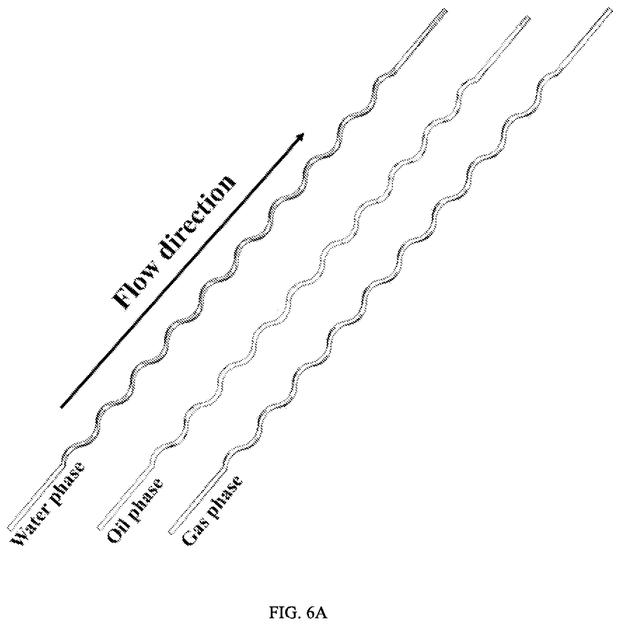

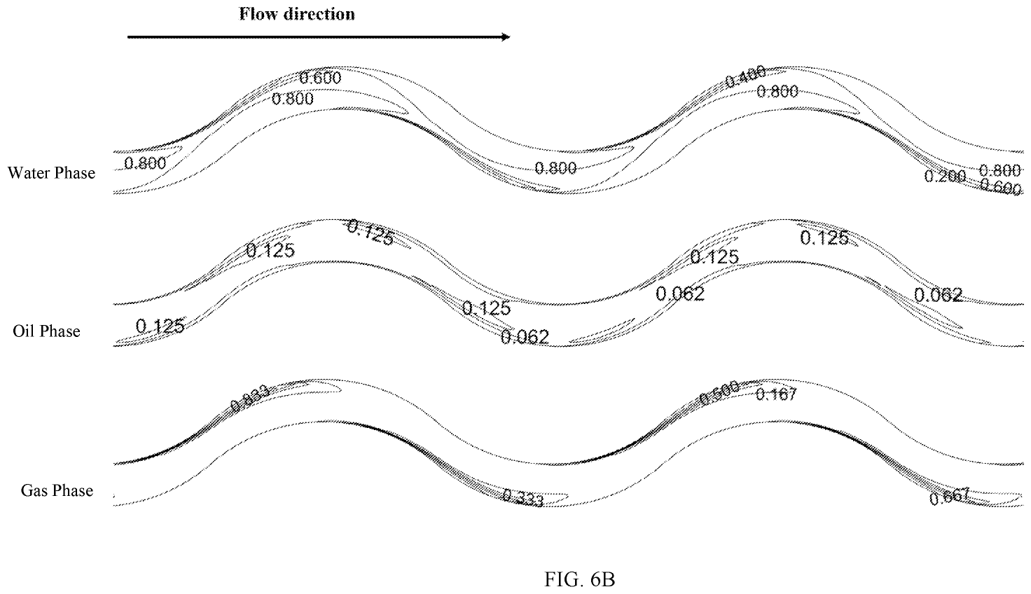

Through a large number of numerical calculations, the flow pattern evolution and the flow heat transfer regularity of oilfield industrial wastewater with specific components are obtained by changing the inflow velocity and temperature (1008). The local Nusselt number of oil-gas-water three-phase flow is defined, the local heat transfer deteriorating area of the heat exchanger are found and the main control mechanism of heat transfer deterioration are revealed (1009). Here, the local Nusselt number and the local gas-phase volume distribution regularities is shown in FIGS. 5A-5B and the cloud diagram of oil-gas-water three-phase distribution in the vertical corrugated channel is shown in FIGS. 6A-6B. FIG. 5A is a schematic diagram of a local Nusselt number and a local gas-phase volume distribution regularities near a left wall of a corrugated channel; FIG. 5B is a schematic diagram of a local Nusselt number and a local gas-phase volume distribution regularities near a right wall of a corrugated channel; FIG. 6A shows a three-phase distribution of a whole corrugated channel, and FIG. 6B shows a three-phase distribution of a 6th to 7th corrugated sections in a channel.

From FIGS. 6A-6B, the distribution regularities of oil-water and gas-water flow patterns in the vertical corrugated channels can be seen clearly. First of all, the continuous water-phase cover the widest area range in the channel, and the content of the water phase is higher at the outer side than that at the inner side of the corrugated channel corner, which is caused by the largest centrifugal force acting on the water phase, because of that it has the highest density among three phases fluid. The oil-water two-phase flow pattern is an oil-in-water foam flow pattern, and oil droplets are almost distributed in the form of oil-in-water in the whole flow region of the corrugated channel, showing the distribution of more numbers in the middle of the channel and less numbers near the wall. Because the thermal resistance of the gas phase is much larger than that of the water phase and the oil phase, the accumulation of gas phase on the wall may lead to the deterioration of heat transfer performance of the corrugated plate heat exchanger. Therefore, this step mainly focuses on the study of the gas-distribution.

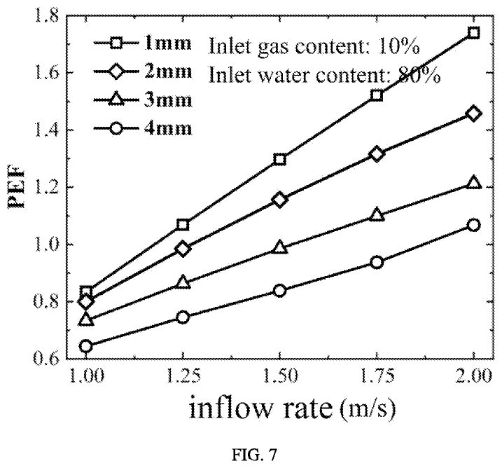

Under the inflow condition of a given composition, temperature and flow velocity, a large number of numerical calculations are carried out by changing the key structural parameters of the heat exchanger, the overall heat transfer performance of the heat exchanger is evaluated by the comprehensive heat transfer factor, and the optimized structure of the heat exchanger is obtained (1010-1011). The key structural parameters of the heat exchanger comprise a corrugation height, a corrugation interval and a corrugation inclination angle, etc. Here, taking the influence of the corrugation height on the comprehensive heat transfer performance factor as shown in FIG. 7 as an example, it can be found that the comprehensive heat transfer performance of the heat exchanger with a corrugation height of 4 mm is obviously higher than the other three heights under the different flow velocity. The specific given inflow conditions are shown in Table 3.

TABLE 3
Setting Table of Given Inflow Conditions

| Parameter name | Oil | Gas | Water | Cooling water |
|---|---|---|---|---|
| Actual velocity v/m · s⁻¹ | 1-2 | 1-2 | 1-2 | 1 |
| Inlet phase volume fraction | 0.1 | 0.1 | 0.8 | 1 |
| Inlet temperature T/K | 321 | 321 | 321 | 293 |

The corrugated channel of the present disclosure is a periodic corrugated channel.

The specific process of defining the local Nusselt number of oil-gas-water three-phase flow, changing the inflow velocity and temperature, and obtaining the flow pattern evolution and the flow and heat transfer regularity of oilfield industrial wastewater with specific components through a large number of numerical calculations, to find the local heat transfer deterioration area of the heat exchanger and reveal the main control mechanism of heat transfer deterioration is as follows.

A large number of numerical calculations are carried out by changing the inflow velocity and temperature. The numerical results are subjected to post-processing to extract the local and global phase volume fraction and size distribution of gas bubbles and oil droplets in the required heat exchanger. The numerical calculation is to calculate the temperature field, the phase field, etc. in the heat exchanger under different working conditions by changing the inlet parameters such as flow velocity and temperature, and then calculate the local Nusselt number through the obtained data, so as to analyze the area where the heat transfer deteriorates in the heat exchanger.

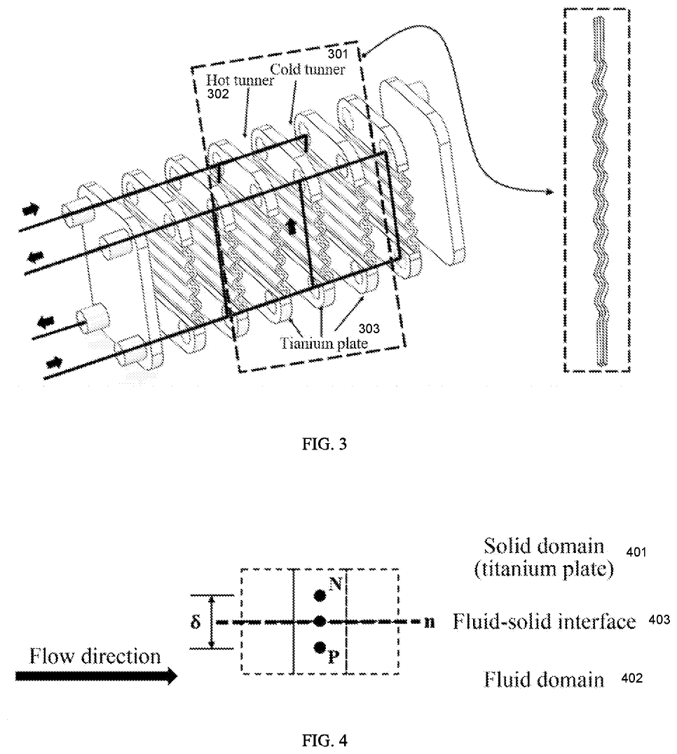

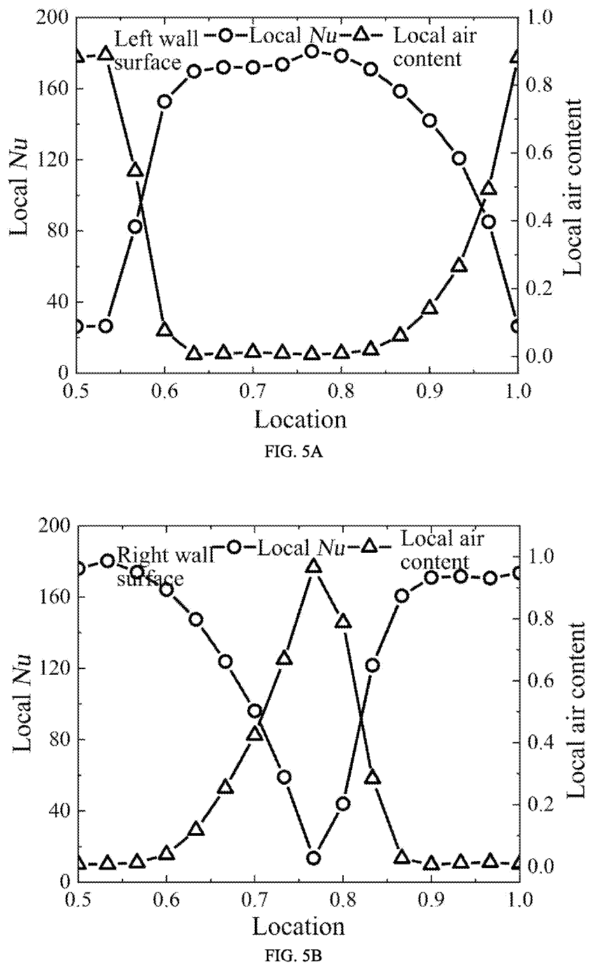

The local Nusselt number of oil-gas-water three-phase flow is defined, and the research object is shown in FIG. 4. The required temperature of each point and the average temperature of the cross section are extracted by post-processing, the equivalent thermal conductivity of the fluid-solid interface is calculated by a harmonic average method, and the corresponding local Nusselt number is calculated by the local heat flux density corresponding to each point. The specific calculation process is as follows:

1) In FIG. 4, the thermal conductivity of the control volumes Ω and N are not equal. According to the principle of continuous heat flux density on the interface, it can be obtained from the Fourier law:

$${q}_{x} = \frac{{T}_{Ω} - {T}_{n}}{\frac{δ}{2} / {λ}_{Ω}} = \frac{{T}_{n} - {T}_{N}}{\frac{δ}{2} / {λ}_{N}} = \frac{{T}_{Ω} - {T}_{N}}{\frac{δ}{2} ( \frac{1}{{λ}_{Ω}} + \frac{1}{{λ}_{N}} )} \qquad ( 25 )$$

According to the meaning of the equivalent thermal conductivity on the interface, there should be:

$${q}_{x} = \frac{{T}_{Ω} - {T}_{N}}{δ / {λ}_{n}} \qquad ( 26 )$$

It can be obtained from the above two formulas:

λₙ=2λ_{Ω} (27)

where qₓ is a heat flux density, λ_{Ω} is a three-phase thermal conductivity in a first layer of grids near a wall 401 of a fluid domain 402, λₙ is an equivalent thermal conductivity of a fluid-solid interface 403, λ_{N} is a thermal conductivity of a solid wall, T_{Ω} is a fluid temperature in a first layer of grids near a wall, Tₙ is a local wall temperature, and T_{N} is a temperature in a first layer of grids of a solid domain. Ω is a first layer of grids near a wall of a fluid domain, and N is a first layer of grids of a solid domain. δ is a height of a first layer of grids near a wall of a fluid domain.

The fluid temperature and the three-phase thermal conductivity are calculated through each phase value obtained by post-processing by the following formula:

λ_{Ω}=αₒλₒα_{g}λ_{g}+α_{W}λ_{W} (28)

T_{Ω}=βₒTₒ+β_{g}T_{g}+β_{W}T_{W} (29)

where α and β indicate a phase volume fraction and a mass fraction, respectively. The subscript g, o and w indicates a gas phase, oil phase and water phase, respectively. α_{W} indicates a water-phase volume fraction, λ_{W} indicates a water-phase thermal conductivity, β_{W} indicates a water-phase mass fraction, and T_{W} indicates a water-phase temperature.

2) According to the energy conservation, the local convective heat transfer coefficient hₓ at this point is obtained from the heat flux density qₓ, and the specific formula is as follows:

$${{{q}_{x} = - {λ}_{n} \frac{\partial T}{\partial y} \vert}_{y = 0} = - 2 {λ}_{Ω} \frac{\partial T}{\partial y} \vert}_{y = 0} = \frac{2 {λ}_{Ω} ( {T}_{Ω} - {T}_{n} )}{δ / 2} = {h}_{x} ( {T}_{f} - {T}_{n} ) \qquad ( 30 )$$

$${h}_{x} = \frac{4 {λ}_{Ω} ( {T}_{Ω} - {T}_{n} )}{δ ( {T}_{f} - {T}_{n} )} \qquad ( 31 )$$

where T_{f} is a temperature of central fluid, δ is a height of the first layer of grids near a wall of a fluid domain, and y is the length in the y direction.

3) The cross-section average thermal conductivity is calculated through the cross-section average volume fraction of three-phase fluid obtained by post-processing, and the local Nusselt number Nuₓ is jointly calculated according to the local convection heat transfer coefficient hₓ obtained by the above solution;

$$N {u}_{x} = \frac{{h}_{x} {D}_{h}}{\overline{{λ}_{xm}}} = \frac{4 {λ}_{Ω} ( {T}_{Ω} - {T}_{n} ) {D}_{h}}{\overline{{λ}_{x m}} ( {T}_{f} - {T}_{n} ) δ} = \frac{4 {λ}_{Ω} ( {T}_{Ω} - {T}_{n} )}{\overline{{λ}_{x m}} ( {T}_{f} - {T}_{n} )} \frac{{D}_{h}}{δ} \qquad ( 32 )$$

where λ̅ₓ̅ₘ̅ is an average thermal conductivity of three-phase fluid in a cross section, and Dₕ is a hydraulic diameter.

The local Nusselt number along a corrugated channel is calculated, and is cooperated with the local gas-phase volume distribution along the corrugated channel extracted by post-processing, so as to find the local heat transfer deteriorated area of the heat exchanger and reveal the control mechanism of heat transfer deterioration as shown in FIGS. 5A-5B.

Specifically, under the inflow condition of a given composition, temperature and flow velocity, a large number of numerical calculations are carried out by changing the key structural parameters of the heat exchanger, the overall heat transfer performance of the heat exchanger is evaluated by the comprehensive heat transfer factor, and the optimized structure of the heat exchanger is obtained, which specifically comprises the following steps.

The Nusselt number of the whole channel is calculated. The required inlet and outlet temperatures, the average temperature of hot fluid and the average temperature of the wall are taken out by post-processing, and the global Nusselt number Nu of the channel is calculated by using the energy conservation equation:

$$N u = \frac{h {D}_{h}}{\overline{{λ}_{v m}}} \qquad ( 33 )$$

$$h = \frac{m {C}_{p} ( {T}_{i n} - {T}_{o u t} )}{{A}_{w} ( {T}_{w} - {T}_{b} )} \qquad ( 34 )$$

$$Nu = \frac{h {D}_{h}}{\overline{{λ}_{v m}}} = \frac{m {C}_{p} {D}_{h} ( {T}_{i n} - {T}_{o u t} )}{\overline{{λ}_{v m}} {A}_{w} ( \overline{{T}_{w}} - {T}_{b} )} \qquad ( 35 )$$

where Cₚ is a specific heat capacity of water at a constant pressure, Tᵢₙ is an inlet temperature of a cold runner, Tₒᵤₜ is an outlet temperature of a cold runner, T_{b} is an average temperature of hot fluid, T̅_̅{̅W̅}̅ is an average temperature of a wetted wall, A_{W}. is an area of a wetted wall, λ̅ᵥ̅ₘ̅ is an average thermal conductivity of three-phase fluid in a volume from hot runner. m is a mass flow, h is a convective heat transfer coefficient, and T_{b} is an average temperature of hot fluid in the channel. The global Nusselt number indicates the overall heat transfer performance of the channel, and the local Nusselt number indicates the heat transfer performance of the local area in the channel. First, the local Nusselt number is used to analyze the local heat transfer deteriorated area. Thereafter, the global Nusselt number is used to measure the overall heat transfer performance of the heat exchanger. The local Nusselt number is used to analyze the reason for the local heat transfer deterioration due to gas accumulates on the wall. The global Nusselt number is approximately equal to the average value of the local Nusselt number, and the heat transfer performance of the heat exchanger is calculated by the global Nusselt number.

Through post-processing, the pressure difference between the inlet and the outlet is obtained, and the Fanning friction factor F is calculated:

$$F = \frac{Δ p \times {D}_{h}}{2 \times L \times ρ \times {v}^{2}} \qquad ( 36 )$$

where F is the Fanning friction factor, Δp is a pressure difference between an inlet and an outlet, L is a channel length, Dₕ is a hydraulic diameter, ν is a flow velocity, and ρ is a density.

In step 105, a comprehensive heat transfer factor is determined according to the Nusselt number and the Fanning friction factor, wherein the comprehensive heat transfer factor is used to evaluate heat transfer performance of the heat exchanger.

The comprehensive heat transfer performance of the vertical corrugated channel is evaluated by using the comprehensive heat transfer factor PEF under the standard condition that the gas content is 0%, the oil content is 10% , the water content is 90%, and the inflow velocity is 1.0 m/s at the inlet of the vertical straight channel:

PEF=(Nu/Nu₀)/(F/F₀)^{1/3} (37)

where PEF is the comprehensive heat exchange factor, Nu is a global Nusselt number, Nu₀ is a global Nusselt number under a standard condition, F is the Fanning friction factor, and F₀ is a Fanning friction factor under the standard condition.

After determining a comprehensive heat transfer factor according to the Nusselt number and the Fanning friction factor, the method further comprises: determining optimized parameters of the heat exchanger according to a plurality of the comprehensive heat transfer factors; wherein the optimization parameters comprise a corrugation height, a corrugation interval and a corrugation inclination angle. By comparing the overall heat transfer performance of the heat exchanger with different structures, the optimized structure of a heat exchanger can be obtained. Specifically, under the same working condition, the single structural parameter of the heat exchanger is changed for numerical calculation, and PEF is obtained based on the single-phase flow without oil and gas under the same flow condition. The calculated structural parameters with the maximal comprehensive heat transfer factor are the optimal structural parameters under the studied working condition. Through a large number of numerical calculations, the optimal parameter values of the corrugation height, the corrugation interval (length) and the corrugation inclination angle under a plurality of working conditions are obtained, which is the optimal structure of the heat exchanger.

Compared with the existing numerical simulation technology of the heat exchanger, the present disclosure belongs to the coupled mechanism model technology for multi-phase flow, which establishes and perfects the fully coupled population balance model for the flow and heat transfer of oil-gas-water three-phase flow by modifying and optimizing the gas bubble/oil droplet interphase transfer mechanism model. The above method reveals the influence of gas bubble/oil droplet movement and size distribution on flow and heat transfer, has high prediction accuracy on the flow pattern evolution and the heat transfer performance of oil-gas-water three-phase flow, and is suitable for the predicting and optimizing flow and heat transfer characteristics in various heat exchangers with oil-water, gas-water two-phase flow and oil-gas-water three-phase flow as the working medium.

The present disclosure further provides a system for predicting heat exchanger performance, comprising an acquiring module, a module of constructing a coupled model of an interphase transfer mechanism for oil-gas-water three-phase flow, a module of constructing a fully coupled population balance model, a solving module, and a comprehensive heat transfer factor determining module.

The acquiring module is configured to acquire a flow unit of the heat exchanger and construct a physical model of the flow unit according to structural parameters of the heat exchanger.

The module of constructing a coupled model of an interphase transfer mechanism for oil-gas-water three-phase flow is configured to construct the coupled model of the interphase transfer mechanism for oil-gas-water three-phase flow using computational fluid dynamics according to the physical model; wherein the coupled model of the interphase transfer mechanism for oil-gas-water three-phase flow comprises an interphase mass transfer model, an interphase momentum transfer model and an interphase energy transfer model.

The module of constructing a fully coupled population balance model is configured to construct the fully coupled population balance model for flow and heat transfer of oil-gas-water three-phase flow according to the coupled model of the interphase transfer mechanism for oil-gas-water three-phase flow; wherein the fully coupled population balance model comprises an Euler multi-fluid model, a water-phase standard k-epsilon turbulence model, and a bubble/oil droplet zero-equation model.

The solving module is configured to solve the fully coupled population balance model to obtain a model calculation result and determine a Nusselt number and a Fanning friction factor according to the model calculation result.

The comprehensive heat transfer factor determining module is configured to determine a comprehensive heat transfer factor according to the Nusselt number and the Fanning friction factor, wherein the comprehensive heat transfer factor is used to evaluate heat transfer performance of the heat exchanger.

In an alternative embodiment, an expression of the interphase momentum transfer model is:

Fₗ=F_{lg}=−F_{gl}

where Fₗ is a total interphase force of water phase, F_{gl} is a interphase force acting on a gas phase in a water phase, and F_{lg} is a interphase force acting on a water phase in a gas phase.

In the present disclosure, by introducing an interphase transfer mechanism model for oil-gas-water three-phase flow, a fully coupled population balance model of oil-gas-water three-phase flow is constructed, so as to predict the flow pattern evolution and the flow and heat transfer regularity of the oil-gas-water three-phase flow, and reveal the influence of bubble/oil droplet movement and size distribution on the flow and heat transfer characteristics. The local deterioration area of heat exchanger performance is found by defining a local heat transfer coefficient, and the overall performance of the heat exchanger is evaluated by a local resistance coefficient, an overall heat transfer coefficient and a comprehensive heat transfer factor. The optimized structural parameters of the heat exchanger with a given composition, temperature and flow velocity are obtained, which provides technical support for the structural optimization of the heat exchanger.

The present disclosure further provides an electronic device, comprising:

one or more processors; and

a storage device on which one or more programs are stored;

wherein the one or more programs, when executed by the one or more processors, cause the one or more processors to implement the method according to any one of the above.

The present disclosure further provides a computer storage medium having a computer program stored thereon, wherein the computer program, when executed by a processor, implements the method according to any one of the above.

In this specification, various embodiments are described in a progressive way, each embodiment focuses on the difference from other embodiments, and the same and similar parts between the various embodiments may refer to each other. Because the system disclosed in the embodiment corresponds to the method disclosed in the embodiment, the system is described simply, and the relevant information refers to the description of the method part.

In the present disclosure, specific examples are applied to illustrate the principles and implementations of the present disclosure. The descriptions of the above embodiments are only used to help understand the method of the present disclosure and core ideas thereof. At the same time, for those skilled in the art, there will be some changes in the specific implementations and the scope of application according to the ideas of the present disclosure. To sum up, the content of the specification should not be construed as limiting the present disclosure.

What is claimed is:

1. A method for predicting heat exchanger performance, comprising:
acquiring a flow unit of a heat exchanger and constructing a physical model of the flow unit according to structural parameters of the heat exchanger;
constructing a coupled model of an interphase transfer mechanism for oil-gas-water three-phase flow using computational fluid dynamics according to the physical model; wherein the coupled model of the interphase transfer mechanism for oil-gas-water three-phase flow comprises an interphase mass transfer model, an interphase momentum transfer model and an interphase energy transfer model;
constructing a fully coupled population balance model for flow and heat transfer of oil-gas-water three-phase flow according to the coupled model of the interphase transfer mechanism for oil-gas-water three-phase flow; wherein the fully coupled population balance model comprises an Euler multi-fluid model, a water-phase standard k-epsilon turbulence model, and a bubble/oil droplet zero-equation model;
solving the fully coupled population balance model to obtain a model calculation result and determining a Nusselt number and a Fanning friction factor according to the model calculation result; and
determining a comprehensive heat transfer factor according to the Nusselt number and the Fanning friction factor, wherein the comprehensive heat transfer factor is used to evaluate heat transfer performance of the heat exchanger.

2. The method according to claim 1, wherein an expression of the interphase momentum transfer model is:
Fₗ=F_{lg}=−F_{gl}
where Fₗ is a total interphase force of water phase, F_{gl} is a interphase force acting on a gas phase in a water phase, and F_{lg} is a interphase force acting on a water phase in a gas phase.

3. The method according to claim 1, wherein an expression of the interphase energy transfer model is:
$${\dot{Q}}_{o , 1} = \frac{{h}_{S , o} {a}_{o} ( {T}_{o} - {T}_{w} )}{{α}_{o}}$$
$${\dot{Q}}_{g , 1} = \frac{{h}_{S , g} {a}_{g} ( {T}_{g} - {T}_{w} )}{{α}_{g}}$$
where \dot{Q}_{o,l} is heat transferred from a water-phase interface to an oil-phase interface, \dot{Q}_{g,l} is heat transferred from a water-phase interface to an gas-phase interface, h_{S,o} is an oil-phase interface transfer coefficient, aₒ is an interface area per unit volume of an oil phase, Tₒ is an oil-phase temperature, T_{W} is a water-phase temperature, h_{S,g} is a gas-phase interface transfer coefficient, a_{g} is an interface area per unit volume of a gas phase, T_{g} is a gas-phase temperature, α_{g} is a gas-phase volume fraction, αₒ is an oil-phase volume fraction.

4. The method according to claim 1, wherein an expression of the Fanning friction factor is:
$$F = \frac{Δ p \times {D}_{h}}{2 \times L \times ρ \times {v}^{2}}$$
where F is the Fanning friction factor, Δp is a pressure difference between an inlet and an outlet, Dₕ is a hydraulic diameter, L is a channel length, ν is a flow velocity, and ρ is a density.

5. The method according to claim 1, wherein an expression of the comprehensive heat exchange factor is:
PEF=(Nu/Nu₀)/(F/F₀)^{1/3}
where PEF is the comprehensive heat exchange factor, Nu is a global Nusselt number, Nu₀ is a global Nusselt number under a standard condition, F is the Fanning friction factor, and F₀ is a Fanning friction factor under the standard condition.

6. The method according to claim 1, wherein after the determining a comprehensive heat transfer factor according to the Nusselt number and the Fanning friction factor, the method further comprises:
determining optimization parameters of the heat exchanger according to a plurality of comprehensive heat exchange factors; wherein the optimization parameters comprise a corrugation height, a corrugation interval and a corrugation inclination angle.

7. A system for predicting heat exchanger performance, comprising:
an acquiring module, configured to acquire a flow unit of a heat exchanger and construct a physical model of the flow unit according to structural parameters of the heat exchanger;
a module of constructing a coupled model of an interphase transfer mechanism for oil-gas-water three-phase flow, configured to construct the coupled model of the interphase transfer mechanism for oil-gas-water three-phase flow using computational fluid dynamics according to the physical model; wherein the coupled model of the interphase transfer mechanism for oil-gas-water three-phase flow comprises an interphase mass transfer model, an interphase momentum transfer model and an interphase energy transfer model;
a module of constructing a fully coupled population balance model, configured to construct the fully coupled population balance model for flow and heat transfer of oil-gas-water three-phase flow according to the coupled model of the interphase transfer mechanism for oil-gas-water three-phase flow; wherein the fully coupled population balance model comprises an Euler multi-fluid model, a water-phase standard k-epsilon turbulence model, and a bubble/oil droplet zero-equation model;
a solving module, configured to solve the fully coupled population balance model to obtain a model calculation result and determine a Nusselt number and a Fanning friction factor according to the model calculation result; and
a comprehensive heat transfer factor determining module, configured to determine a comprehensive heat exchange factor according to the Nusselt number and the Fanning friction factor, wherein the comprehensive heat transfer factor is used to evaluate heat transfer performance of the heat exchanger.

8. The system according to claim 7, wherein an expression of the interphase momentum transfer model is:
Fₗ=F_{lg}=−F_{gl}
where Fₗ is a total interphase force of water phase, F_{gl} is a interphase force acting on a gas phase in a water phase, and F_{lg} is a interphase force acting on a water phase in a gas phase.

9. An electronic device, comprising:
one or more processors; and
a storage device on which one or more programs are stored;
wherein the one or more programs, when executed by the one or more processors, cause the one or more processors to implement the method according to claim 1.

10. The electronic device according to claim 9, wherein an expression of the interphase momentum transfer model is:
Fₗ=F_{lg}=−F_{gl}
where Fₗ is a total interphase force of water phase, F_{gl} is a interphase force acting on a gas phase in a water phase, and F_{lg} is a interphase force acting on a water phase in a gas phase.

11. The electronic device according to claim 9, wherein an expression of the interphase energy transfer model is:
$${\dot{Q}}_{o , 1} = \frac{{h}_{S , o} {a}_{o} ( {T}_{o} - {T}_{w} )}{{α}_{o}}$$
$${\dot{Q}}_{g , 1} = \frac{{h}_{S , g} {a}_{g} ( {T}_{g} - {T}_{w} )}{{α}_{g}}$$
where \dot{Q}_{o,l} is heat transferred from a water-phase interface to an oil-phase interface, \dot{Q}_{g,l} is heat transferred from a water-phase interface to an gas-phase interface, h_{S,o} is an oil-phase interface transfer coefficient, aₒ is an interface area per unit volume of an oil phase, Tₒ is an oil-phase temperature, T_{W} is a water-phase temperature, h_{S,g} is a gas-phase interface transfer coefficient, a_{g} is an interface area per unit volume of a gas phase, T_{g} is a gas-phase temperature, α_{g} is a gas-phase volume fraction, αₒ is an oil-phase volume fraction.

12. The electronic device according to claim 9, wherein an expression of the Fanning friction factor is:
$$F = \frac{Δ p \times {D}_{h}}{2 \times L \times ρ \times {v}^{2}}$$
where F is the Fanning friction factor, Δp is a pressure difference between an inlet and an outlet, Dₕ is a hydraulic diameter, L is a channel length, ν is a flow velocity, and ρ is a density.

13. The electronic device according to claim 9, wherein an expression of the comprehensive heat exchange factor is:
where PEF=(Nu/Nu₀)/(F/F₀)^{1/3} is the comprehensive heat exchange factor, Nu is a global Nusselt number, Nu₀ is a global Nusselt number under a standard condition, F is the Fanning friction factor, and F₀ is a Fanning friction factor under the standard condition.

14. The electronic device according to claim 9, wherein after the determining a comprehensive heat transfer factor according to the Nusselt number and the Fanning friction factor, the method further comprises:
determining optimization parameters of the heat exchanger according to a plurality of comprehensive heat exchange factors; wherein the optimization parameters comprise a corrugation height, a corrugation interval and a corrugation inclination angle.

15. A computer storage medium having a computer program stored thereon, wherein the computer program, when executed by a processor, implements the method according to claim 1.

16. The computer storage medium according to claim 15, wherein an expression of the interphase momentum transfer model is:
Fₗ=F_{lg}=−F_{gl}
where Fₗ is a total interphase force of water phase, F_{gl} is a interphase force acting on a gas phase in a water phase, and F_{lg} is a interphase force acting on a water phase in a gas phase.

17. The computer storage medium according to claim 15, wherein an expression of the interphase energy transfer model is:
$${\dot{Q}}_{o , 1} = \frac{{h}_{S , o} {a}_{o} ( {T}_{o} - {T}_{w} )}{{α}_{o}}$$
$${\dot{Q}}_{g , 1} = \frac{{h}_{S , g} {a}_{g} ( {T}_{g} - {T}_{w} )}{{α}_{g}}$$
where \dot{Q}_{o,l} is heat transferred from a water-phase interface to an oil-phase interface, \dot{Q}_{g,l} is heat transferred from a water-phase interface to an gas-phase interface, h_{S,o} is an oil-phase interface transfer coefficient, aₒ is an interface area per unit volume of an oil phase, Tₒ is an oil-phase temperature, T_{W} is a water-phase temperature, _{S,g} is a gas-phase interface transfer coefficient, a_{g} is an interface area per unit volume of a gas phase, T_{g} is a gas-phase temperature, α_{g} is a gas-phase volume fraction, αₒ is an oil-phase volume fraction.

18. The computer storage medium according to claim 15, wherein an expression of the Fanning friction factor is:
$$F = \frac{Δ p \times {D}_{h}}{2 \times L \times ρ \times {v}^{2}}$$
where F is the Fanning friction factor, Δp is a pressure difference between an inlet and an outlet, Dₕ is a hydraulic diameter, L is a channel length, ν is a flow velocity, and ρ is a density.

19. The computer storage medium according to claim 15, wherein an expression of the comprehensive heat exchange factor is:
PEF=(Nu/Nu₀)/(F/F₀)^{1/3}
where PEF is the comprehensive heat exchange factor, Nu is a global Nusselt number, Nu₀ is a global Nusselt number under a standard condition, F is the Fanning friction factor, and F₀ is a Fanning friction factor under the standard condition.

20. The computer storage medium according to claim 15, wherein after the determining a comprehensive heat transfer factor according to the Nusselt number and the Fanning friction factor, the method further comprises:
determining optimization parameters of the heat exchanger according to a plurality of comprehensive heat exchange factors; wherein the optimization parameters comprise a corrugation height, a corrugation interval and a corrugation inclination angle.
